(19) United States
(12) Patent Application Publication
(10) Pub. No.: US 2014/0280053 A1
(43) Pub. Date: Sep. 18, 2014

(54) CONTEXTUAL SOCIALLY AWARE LOCAL SEARCH

(71) Applicant: MICROSOFT CORPORATION, Redmond, WA (US)

(72) Inventors: Patrick Joseph Derks, Seattle, WA (US); Darin James Dishneau, Snoqualmie, WA (US); Sandeep Paruchuri, Seattle, WA (US); Sujeet Mehta, Kirkland, WA (US); Vasan Jiaramaneetwesin, Redmond, WA (US); Scott Borton, Seattle, WA (US)

(73) Assignee: MICROSOFT CORPORATION, Redmond, WA (US)

(21) Appl. No.: 13/831,321

(22) Filed: Mar. 14, 2013

(51) Int. Cl. G06F 17/30

(52) U.S. Cl. CPC G06F 17/30554
USPC 707/722

(57) ABSTRACT

Methods, systems, and computer program products are provided for determining a meeting location. A group of persons to meet is determined. A conjoined interest set is generated that is representative of the group of persons. Locations of persons in the group are determined to determine a plurality of locations. Local search results for the group of persons are received that are generated based on the conjoined interest set and the determined plurality of locations. The local search results include at least one potential meeting location. The local search results are enabled to be presented to at least one person of the group of persons.

### BACKGROUND

A search engine is an information retrieval application that is used to locate documents and other information. Search engines are useful at reducing an amount of time required to find information. One well known type of search engine is a Web search engine that searches for documents, including web pages, image files, video files, and other web objects on the “World Wide Web” (also known as “the Web”). “Local search” refers to the use of search engines that enable users to submit geographically constrained searches against a structured database of local business listings. Local search is a popular function that is built into or is accessible as a third party application by computing devices such as smart phones and computers. Local search enables an individual user to search for merchants (e.g., restaurants, coffee shops, etc.), attractions (museums), and further types of destinations based on the user's current location.

A common problem with local search is the plethora of destination options available in a metropolitan setting. There can be literally hundreds (sometimes thousands) of local search results for a relatively small geographic area. Wading through these lengthy results can be time consuming and problematic when searching for a destination. Local search has been improved somewhat by taking characteristics of the user into account. Local search, however, is still limited to searches performed by individual users, among other deficiencies.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Methods, systems, and computer program products are provided for determining meeting locations for groups of people. A group of persons may be determined manually or automatically, or by a combination of manual and automatic techniques. Profile information (e.g., interests, preferences, and other characteristics) associated with the persons in the group may be determined by polling available information, and the determined information may be analyzed to determine an intersection of the interests of the group. Locations of the persons of the group may be determined, and a rough center location for the group may be determined based on the determined locations. The determined profile information and rough center location of the group may be issued in a local search query to automatically determine a meeting place for the group.

In one implementation, a method for determining a meeting location is provided. A group of persons to meet is determined. A conjoined interest set is generated that is representative of the group of persons. Locations of persons in the group are determined to determine a plurality of locations. Local search results for the group of persons are received that are generated based on the conjoined interest set and the determined plurality of locations. The local search results include at least one potential meeting location. The local search results are enabled to be presented to at least one person of the group of persons.

In another implementation, a system for determining a meeting location is provided. The system includes a group determiner, an interest set generator, a location determiner, a local search service interface, and an output interface. The group determiner is configured to determine a group of persons to meet. The interest set generator is configured to generate a conjoined interest set that is representative of the group of persons. The location determiner is configured to determine locations of persons in the group. The local search service interface is configured to receive local search results for the group of persons generated based on the conjoined interest set and the determined locations. The local search results include at least one potential meeting location. The output interface is configured to enable the local search results to be presented to at least one person of the group of persons.

The group determiner may be configured to generate a user interface to enable the group of persons to be manually defined, and/or may be configured to automatically determine the group of persons.

Furthermore, the interest set generator may include a profile information retriever and a profile intersection determiner. The profile information retriever may be configured to retrieve profile information for each person of the group. The profile intersection determiner is configured to determine an intersection of the retrieved profile information to generate the conjoined interest set.

The profile information retriever may be configured to receive profile information for at least one person of the group from at least one of a social network, a search engine, contact information associated with the person, and/or other source of profile information. The profile information retriever may include a message thread analyzer configured to analyze a message thread of at least one person of the group for at least one of interest information, time information, or meeting place suggestions.

The interest set generator may include a preference tuner configured to generate a user interface to enable a coordinator for the group to manually tune at least one preference for the group of persons.

The system may further include a statistics generator configured to generate statistics associated with the conjoined interest set to be presented by the output interface to at least one person of the group of persons.

A computer readable storage medium is also disclosed herein having computer program instructions stored therein that enable a processor to determine a meeting location, as well as enabling additional embodiments described herein.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 shows a block diagram of a communication system that enables a meeting location to be automatically determined for a group, according to an example embodiment.

FIG. 2 shows a flowchart providing a process that enables a meeting location to be automatically determined for a group, according to an example embodiment.

FIG. 3 shows a block diagram of a meeting system that enables a meeting location to be automatically determined for a group, according to an example embodiment.

FIG. 4 shows a block diagram of a communication system in which a group determiner determines a group of persons that is to gather together, according to an example embodiment.

FIG. 5 shows a flowchart providing a process for determining a conjoined interest set for a group, according to an example embodiment.

FIG. 6 shows a block diagram of a communication system in which an interest set generator determines a conjoined interest set for a group, according to an example embodiment.

FIG. 7 shows a block diagram of a profile information retriever, according to an example embodiment.

FIG. 8 shows a block diagram of a communication system in which a profile intersection determiner enables tuning of group meeting preferences, according to an example embodiment.

FIG. 9 shows a block diagram of a communication system in which an output interface enables local search results and related statistics to be presented, according to an example embodiment.

FIGS. 10-15, 16A, and 16B show block diagrams of user interfaces that enable a meeting location to be determined for a group, according to example embodiments.

FIG. 17 shows a block diagram of an example computing device that may be used to implement embodiments of the present invention.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The present specification discloses one or more embodiments that incorporate the features of the invention. The disclosed embodiment(s) merely exemplify the invention. The scope of the invention is not limited to the disclosed embodiment(s). The invention is defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Numerous exemplary embodiments of the present invention are described as follows. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Example Embodiments

One well known type of search engine is a Web search engine that searches for documents, including web pages, image files, video files, and other web objects on the “World Wide Web” (also known as “the Web”). “Local search” refers to the use of search engines that enable users (“users” and “persons” are used interchangeably herein) to submit geographically constrained searches against a structured database of local business listings. Local search is a popular function that is built into or is accessible as a third party application by computing devices such as smart phones and computers. Local search enables a user to search for merchants (e.g., restaurants, coffee shops, etc.), attractions (museums) and further types of destinations based on the user's current location.

A common problem with local search is the plethora of destination options available in a metropolitan setting. There can be literally hundreds (sometimes thousands) of local search results for a relatively small geographic area. Wading through these results by a user can be time consuming and problematic when searching for a destination. Recently, local search has been improved by taking the interests of the user into account, and sorting the local search results based on the user's interests.

However, local search currently does not handle searches performed in the context of a group of people. Embodiments described herein overcome these deficiencies of current local search techniques. Embodiments enable locations to be determined for a group of persons, while taking into account the interests of the persons in the group. Furthermore, such embodiments may enable a meeting location to be determined for a group of persons in a fully automatic or semi-automatic manner (e.g., enabling a user to manually select one more meeting participants, to manually tune meeting characteristics, etc.).

For instance, in one example, a group of users may be defined by context such as by being a part of a virtual “family room,” a custom “group,” a joint messaging thread, or other accessible listing or grouping of persons. After the group is defined, the locations of persons in the group may be queried, and traffic conditions around the persons may be analyzed to determine an approximate “center area” or “center location” for the group to meet, based on distance and/or substantially equivalent travel time. Once this “center area” is defined, preferences of the persons may be polled in any manner (e.g., using a search engine, etc.) to enable a recommended location to meet to be determined that is a destination that the group is likely to enjoy. For instance, a highly rated coffee shop, restaurant, or other location may be recommended, also taking into account the time of day.

In another example, if a user is with a group of young college friends, local search results may be generated that are filtered and/or ordered based on the likelihood that the group will like a particular destination (e.g., a hip bar with karaoke). Alternatively, if the user is with a group of people with young children, local search results may be generated that are filtered/ordered based on destinations that would likely be amenable to that group (e.g., finding a nearby coffee shop with a play area, etc.). In still another example, if a member of a group is an “out of town” guest (e.g., the user has a residence address that is not in the local area), local search results may be generated to emphasize popular tourist attractions or restaurants.

Such embodiments may be implemented in a variety of environments. For instance, FIG. 1 shows a block diagram of a communication system 100 that enables a meeting location to be automatically determined for a group, according to an example embodiment. As shown in FIG. 1, system 100 includes first-nth computing devices 102a-102n (computing devices 102a, 102b, and 102n are explicitly shown in FIG. 1), a first server 104, storage 106, a second server 108, and a network 110. As further shown in FIG. 1, computing devices 102a, 102b, and 102n respectively include an application 112, a mobile app 124, and a web application 116. Still further, first server 104 includes a meeting system 118, and second server 108 includes a local search service 120. These features of communication system 100 are described as follows.

Computing devices 102a-102n may each be any type of stationary or mobile computing device, including a desktop computer (e.g., a personal computer, etc.), a mobile computer or computing device (e.g., a Microsoft® Surface® device, a Palm® device, a RIM Blackberry® device, a personal digital assistant (PDA), a laptop computer, a notebook computer, a tablet computer such as an Apple iPad™, a netbook, etc.), a mobile phone (e.g., a cell phone, a smart phone such as a Microsoft Windows® phone, an Apple iPhone, a Google Android™ phone, etc.), or other type of mobile device. First server 104 and second server 108 may each be implemented in one or more computer systems, including one or more servers which may be any type of computing devices described herein or otherwise known that is/are capable of enabling the corresponding functionality described herein.

Computing devices 102a-102n, first server 104, and second server 108 are communicatively coupled by network 110. Network 110 may include one or more communication links and/or communication networks, such as a PAN (personal area network), a LAN (local area network), a WAN (wide area network), or a combination of networks, such as the Internet. Computing devices 102a, 102b, and 102n, and first server 104 may be communicatively coupled to network 110 using various links, including wired and/or wireless links, such as IEEE 802.11 wireless LAN (WLAN) wireless links, Worldwide Interoperability for Microwave Access (Wi-MAX) links, cellular network links, wireless personal area network (PAN) links (e.g., Bluetooth™ links), Ethernet links, USB links, etc.

Computing devices 102a-102n are each associated with a user that interacts with the respective computing device as described herein. A number “n” of computing devices 102a-102n is shown in FIG. 1 for purposes of illustration. Any number of two or more computing devices may be present in system 100, including tens, hundreds, thousands, and even greater numbers of computing devices. Each computing device may operate one or more corresponding applications.

Note that in an embodiment, meeting system 118 may be included in a server, such as shown in FIG. 1. In another embodiment, meeting system 118 may be included in one of computing devices 102a-102n of a user of the group.

As shown in FIG. 1, storage 106 is coupled to server 104. Storage 106 may be directly connected to first server 104, or may be coupled to first server 104 through network 110. Storage 106 stores profile information 122. Storage 106 may have the format of a database or other format, and may include one or more of any type of storage mechanism to store profile information 122, including a magnetic disc (e.g., in a hard disk drive), an optical disc (e.g., in an optical disk drive), a magnetic tape (e.g., in a tape drive), a memory device such as a RAM device, a ROM device, etc., and/or any other suitable type of storage medium.

Computing devices 102a-102n are computing devices used by associated persons for any number and type of functions. Such persons may be interested in meeting together at a location. For example, a user of one of computing devices 102a-102n may interact with their computing device to request that a meeting place be determined, according to embodiments. The user may interact with a user interface displayed by an application at their computing device (e.g., a web page displayed by a web browser, or a user interface provided by another form of application), such as a user interface displayed by application 112 at computing device 102a, mobile app 124 at computing device 102b, or web application 116 at computing device 102n. As shown in FIG. 1, a meeting request 114 may be transmitted from one of computing devices 102a-102n due to the user interacting with the corresponding user interface. For example, computing device 102a may transmit meeting request 114 in a communication signal through network 110 to be received by meeting system 118 at first server 104. The communication signal may be transmitted in any form.

As shown in FIG. 1, meeting system 118 at server 104 may receive meeting request 114. In response to receiving meeting request 114, meeting system 118 determines a meeting location for a group of persons. Meeting system 118 may determine the persons to include in the group manually or automatically. For instance, meeting system 118 may enable a person at one of computing devices 102a-102n to manually select the persons to be included in the group, and may enable persons to opt-in or opt-out of the group. Alternatively, meeting system 118 may automatically select the persons to include in the group based on context. For instance, meeting system 118 may automatically include persons in the group that were participating together in a meeting (e.g., as indicated by a calendar appointment), were participating together in a messaging thread (e.g., an email chain, a text messaging thread, a chat room, a social network discussion/comment thread, etc.), are associated together in a social network circle (e.g., a friends group, a family group, an online group, etc.), were located at a same geographical location at the time meeting request 114 was issued, or were associated in another manner.

Meeting system 118 may access profile information 122 from a plurality of profiles included in storage 106 for the persons in the determined group. Meeting system 118 may analyze profile information 122 to determine overlaps in demographic information, interests, preferences, and/or other profile information regarding the persons to determine a conjoined interest set for the persons. Furthermore, meeting system 118 may determine a location for each person in the group, and may analyze the determined locations to generate an approximate geographical center location (e.g., based on distance and/or travel time) for the group.

Meeting system 118 may provide the conjoined interest set and the determined center location for the group in a local search request 126 transmitted from first server 104 to local search service 120 at second server 108. Local search service 120 is a search engine that enables users to submit geographically constrained searches against a structured database of local business listings. As such, local search request 126 may include information from the determined conjoined interest set to be used by local search service 120 as describing “what” is being searched for. The information of the determined conjoined interest set may be in the form of keywords and/or a structured search query that defines interests/preferences such as restaurant types, food preferences, drink preferences, hobbies, other specific interests, etc., as well as demographic information such as average age of the group, whether members of the group have children, etc. Furthermore, local search request 126 may include the center location to be used by local search service 120 as the “where” information for selecting a meeting location. The center location may be in any form of location defining information, such as a street address, a city name, a postal code, geographic coordinates (e.g., latitude and longitude), a name of a landmark (e.g., a monument name, a park name, etc.), a name of a business location (e.g., a hotel name, a business name, etc.), or in another form.

Local search service 120 may process the determined conjoined interest set and the center location to select one or more possible meeting locations for the group. Local search service 120 may provide the one or more possible meeting locations in a local search response 128 transmitted from second server 108 to meeting system 118 at first server 104. Note that in another embodiment, local search service 120 and meeting system 118 may be located in a common server.

In response to meeting request 114, meeting system 118 is configured to provide the one or more possible meeting locations in local search results 130 transmitted from first server 104 to one or more of computing devices 102a-102n. For instance, in one embodiment, local search results 130 may be transmitted to a single computing device associated with the user that submitted meeting request 114 (e.g., computing device 102a). A single (e.g., highest ranked) possible meeting location may be presented, or a list of possible meeting locations may be presented. In this manner, the user (e.g., a coordinator for the group) may review the one or more possible meeting locations, and select one of the possible meeting locations to be the selected meeting location for the group. The user may distribute the selected meeting location to other users of the group in any manner, including by a message transmitted through network 110 or in another manner.

In another embodiment, local search results 130 may be transmitted to all computing devices associated with persons in the group (e.g., two or more of computing devices 102a-102n). In this manner, the persons of the group may review the one or more possible meeting locations, and may select one of the possible meeting locations by voting on the possible meeting locations or in another manner. The selected meeting location may be indicated to all users of the group in any manner, including by a message transmitted through network 110, by displaying a vote tally for the possible meeting locations, or in another manner.

The elements of communication system 100 shown in FIG. 1 may be configured in various ways, in embodiments. Example embodiments for the elements of communication system 100 are described in the following subsections.

A. Example Embodiments for Meeting Systems

As described above, in embodiments, meeting systems are enabled to select meeting locations for groups of persons. Such meeting systems may be configured in various ways, and may perform their functions in various ways. For instance, FIG. 2 shows a flowchart 200 providing a process that enables a meeting location to be automatically determined for a group, according to an example embodiment. Meeting system 118 of FIG. 1 may operate according to flowchart 200, in an embodiment. For purposes of illustration, flowchart 200 of FIG. 2 is described with respect to FIG. 3. FIG. 3 shows a block diagram of a meeting system 300 that enables a meeting location to be determined for a group, according to an example embodiment. Meeting system 300 is an example of meeting system 118 of FIG. 1. As shown in FIG. 3, meeting system 300 includes a group determiner 302, a location determiner 304, an interest set generator 306, a local search service interface 308, and an output interface 310. Flowchart 200 and meeting system 300 are described as follows. Note that the steps of flowchart 200 may be performed in orders other than the order shown in FIG. 2. Further structural and operational embodiments will be apparent to persons skilled in the relevant art(s) based on the following description.

Flowchart 200 begins with step 202. In step 202, a group of persons to meet is determined. As shown in FIG. 3, group determiner 302 of meeting system 300 may receive meeting request 114. Group determiner 302 may be configured to determine persons to include in the group of persons. The determined group of persons includes persons that are to be invited to meet at a location as determined herein. In embodiments, group determiner 302 may be configured to determine the persons to include in the group manually or automatically. Furthermore, group determiner 302 may enable persons to opt-in or opt-out of the group.

For example, FIG. 4 shows a block diagram of a portion of communication system 100 of FIG. 1, in which group determiner 302 (in server 104) determines a group of persons to gather together, according to an example embodiment. As shown in FIG. 4, group determiner 302 includes a manual input enabler 402 and an automatic group generator 404. Either or both of manual input enabler 402 and automatic group generator 404 may be present. Manual input enabler 402 is configured to receive manually input participants for the group, and automatic group generator 404 is configured to automatically generate the group of persons. As shown in FIG. 3, group determiner 302 generates a determined group indication 312, which indicates the persons included in the determined group.

As shown in FIG. 4, manual input enabler 402 may generate a user interface definition 406, which is transmitted from first server 104 through network 110 to computing device 102a in a communication signal. User interface definition 406 may have any form, including being a textual document, a code file (e.g., JAVA, JavaScript, etc.), a web document (e.g., a web page coded in a least one of HTML, XML (extensible markup language), and/or other code), or other form. User interface definition 406 defines a user interface that enables a user to manually define participants of the group.

For instance, as shown in FIG. 4, application 112 at computing device 102a may generate a user interface 408 based on user interface definition 406. Application 112 may include a web browser that renders user interface 408 based on a web document version of user interface definition 406. Alternatively, user interface 408 may be generated in other ways based on user interface definition 406. User interface 408 may include any number and combination of user interface elements to enable members of a group to be defined. Examples of such user interface elements include graphical icons, visual indicators, menus, radio buttons, check boxes, sliders, etc. A user at computing device 102a (e.g., a group coordinator) may be enabled to select persons to include in the group in various ways by interacting with user interface 408, such as by entering names in a text box, selecting persons from a contacts list, and/or in other ways.

As shown in FIG. 4, application 112 may generate a group list 410 that includes a list of persons included in the group. Group list 410 is transmitted from computing device 102a through network 110 to manual input enabler 402 in first server 104.

Alternatively, automatic group generator 404 may automatically determine the persons to include in the group. For example, automatic group generator 404 may be configured to analyze one or more data structures to automatically determine persons to include in the group based on context. For instance, automatic group generator 404 may generate the group to include persons from an eligible persons pool that are determined to be located in a particular geographical area, to generate the group to include persons from an eligible persons pool that are determined to be located within a particular radial distance from a location designated by a coordinator for the group, to generate the group to include persons from an eligible persons pool that are determined to be located within a particular travel time from a location designated by a coordinator for the group, or to generate the group based on a grouping of persons formed online.

For example, an eligible persons pool may include persons listed in a particular contacts list, persons that were participating together in a meeting (e.g., as indicated by a calendar appointment), persons that were participating together in a messaging thread (e.g., an email chain, a text messaging thread, a chat room, a social network discussion/comment thread, etc.), persons that are associated together in a social network circle (e.g., a friends group, a family group, another custom online group, etc.), persons that were located at a same geographical location at the time meeting request 114 was issued, or persons that were associated in another manner.

Automatic group generator 404 may access any of these eligible persons pools, such as by accessing a contacts list for a phone or messaging tool, a contact management application or database, a calendar tool for an appointment (e.g., Microsoft® Outlook® developed by Microsoft Corporation of Redmond, Wash., etc.), a message thread (e.g., an email, a text message, a chat thread, a social network discussion thread, etc.), an online social network for a social group, etc. For example, as shown in FIG. 4, automatic group generator 404 may receive group information 412, which may include a contacts list, a calendar appointment, a message thread, a social group indication, etc. Automatic group generator 404 may analyze group information 412 to generate a group of persons by including the persons found in the data structure included in group information 412 (e.g., persons in the contact list, persons listed in an appointment, persons included in a messaging thread, persons included in a social group, etc.).

Additionally, automatic group generator 404 may receive user location information 414, which indicates a location of persons included in group information 412. In an embodiment, automatic group generator 404 may use user location information 414 to include or filter out one or more persons from the group based on their location. For instance, automatic group generator 404 may generate the group to include persons of the eligible persons pool that are determined to be located in a particular geographical area (e.g., within a particular room, building, park, town, or other area), to include persons from the eligible persons pool that are determined to be located within a particular radial distance from a location designated by a coordinator for the group (e.g., a location of computing device 102a), to include persons from an eligible persons pool that are determined to be located within a particular travel time from a location designated by a coordinator for the group (e.g., as determined based on traffic conditions, time of day, etc.), and/or to include persons based on other location-based constraints.

User location information 414 may indicate user locations determined in any manner, including by IP (Internet protocol) address of a computing device of a user (e.g., for stationary devices), by location determining techniques such as GPS (global positioning system), cell tower triangulation, or Bluetooth® proximity, by users manually providing position information (e.g., by message), and/or by other techniques.

Accordingly, by manual or automatic techniques, group determiner 302 may generate determined group indication 312 to define the persons included in the group. In an embodiment, a user (e.g., a group coordinator) may be enabled to interact with user interface 408 to be displayed the list of persons included in the group, and to manually modify the group of persons, whether the group was generated manually or automatically.

Referring back to FIG. 2, in step 204, a conjoined interest set is generated that is representative of the group of persons. As shown in FIG. 3, interest set generator 306 of meeting system 300 may receive determined group indication 312. Interest set generator 306 may be configured to retrieve profile information 122 for persons of the group indicated by determined group indication 312, and to generate a conjoined interest set 316 for the group. Conjoined interest set 316 is configured as an intersection of interests of the persons of the group, and therefore represents a combined set of interests for the group.

Interest set generator 306 may be configured to generate conjoined interest set 316 in various ways. For instance, FIG. 5 shows a flowchart 500 providing a process for determining a conjoined interest set for a group, according to an example embodiment. Interest set generator 306 may operate according to flowchart 500, in an embodiment. For purposes of illustration, flowchart 500 of FIG. 5 is described with respect to FIG. 6. FIG. 6 shows a block diagram of communication system 100 of FIG. 1, in which interest set generator 306 (in first server 104) determines a conjoined interest set for a group, according to an example embodiment. As shown in FIG. 6, interest set generator 306 includes a profile information retriever 602 and a profile intersection determiner 604. Flowchart 500 and interest set generator 306 of FIG. 6 are described as follows. Further structural and operational embodiments will be apparent to persons skilled in the relevant art(s) based on the following description.

Flowchart 500 begins with step 502. In step 502, profile information for persons of the group is received. As shown in FIG. 6, profile information retriever 602 of interest set generator 306 receives determined group indication 312. In an embodiment, profile information retriever 602 attempts to obtain profile information for each person included in the group indicated by determined group indication 312. In some cases, profile information retriever 602 may retrieve profile information for each person, and in other cases, profile information retriever 602 may retrieve profile information for fewer than all of the persons in the group (e.g., due to an inability to locate or access such profile information, due to privacy settings of a user enabling them to opt-out of providing access to their profile information, etc.). In any event, as shown in FIG. 6, profile information retriever 602 outputs the retrieved profile information as retrieved profile information 612.

Profile information retriever 602 may retrieve the profile information from one or more sources. For instance, as shown in FIG. 6, profile information retriever 602 may be communicatively coupled through network 110 with one or more of a social network 606, a search engine 608, and a messaging server 610. Profile information retriever 602 may transmit a profile information request 126a to social network 606 through network 110 to retrieve social network profile information 128a for one or more persons. Profile information retriever 602 may transmit a profile information request 126b to search engine 608 through network 110 to retrieve search engine profile information 128b for one or more persons. Profile information retriever 602 may transmit a profile information request 126c to messaging server 610 through network 110 to retrieve messaging server profile information 128c for one or more persons. In further embodiments, profile information retriever 602 may communicate with additional and/or alternative entities to retrieve profile information for persons of the group. For instance, in an embodiment, profile information retriever 602 may retrieve profile information for a user from a computing device of the user (e.g., from profile information stored therein, from one or more cookies stored on the computing device, etc.).

Each of social network profile information 128a, search engine profile information 128b, messaging server profile information 128c, and profile information received from other source(s) may include any type of profile information for a person, such as preference information (e.g., preferred restaurant types, food preferences, favorite cuisines, drink preferences, favorite places, food requirements due to allergies, accessibility needs due to physical handicaps, etc.), interest information (e.g., hobbies, travel destinations, favorite sports, other specific interests, etc.), demographic information (e.g., age, sex, location of residence, marital status, socio-economic status, whether the person has children, etc.), and any other suitable profile information type.

Some examples of social network 606 provided for illustrative purposes include Facebook® operated by Facebook, Inc. of Palo Alto, Calif., Google+ operated by Google, Inc. of Mountain View, Calif., etc., LinkedIn® operated by LinkedIn Corporation of Mountain View, Calif., Twitter, Inc. of San Francisco, Calif., and Foursquare provided by Foursquare Labs, Inc. of New York City, New York, as well as social groups (e.g., friends, family, and/or other groups) enabled by online services such as Windows Live™ provided by Microsoft Corporation, and social groups (e.g., friends, family, and/or other groups) enabled on computing devices such as Microsoft Windows® phone. Examples of search engine 608 include Yahoo! Search™ (at http://www.yahoo.com) provided by Yahoo! Inc. of Sunnyvale, Calif., Microsoft® Bing™ (at http://www.bing.com), and Google™ (at http://www.google.com). Examples of messaging server 610 include an email server (e.g., outlook.com provided by Microsoft Corporation, gmail.com provided by Google Inc., yahoo.com provided by Yahoo! Inc., etc.), a text messaging server, a chat server, etc.

In an embodiment, profile information retriever 602 may be configured to analyze received message threads for profile information to include in retrieved profile information 612. For instance, FIG. 7 shows a block diagram of profile information retriever 602, according to an example embodiment. As shown in FIG. 7, profile information retriever 602 includes a message thread analyzer 702. Message thread analyzer 702 is configured to analyze a message thread of at least one person of the group for at least one of interest information, time information, meeting place suggestions, and/or further relevant information. Message thread analyzer 702 may be configured to analyze any number and type of messaging thread, such as an email, a text messaging thread, a chat room discussion, a social network discussion, etc. For instance, message thread analyzer 702 may be configured to parse a messaging thread for names of persons, and any corresponding comments made by the persons regarding their preferences, interests, etc. (e.g., preferences for or dislikes of particular food, restaurants, stores, business locations, tourist destinations, etc.). Message thread analyzer 702 may include this determined information in retrieved profile information 612 for the corresponding persons.

Referring back to FIG. 5, in step 504 of flowchart 500, an intersection of the retrieved profile information is determined to generate the conjoined interest set. As shown in FIG. 6, profile intersection determiner 604 of interest set generator 306 receives retrieved profile information 612. In an embodiment, profile intersection determiner 604 is configured to analyze retrieved profile information 612 to determine overlaps in the profile information of the persons of the group to determine conjoined interest set 316, which indicates a combined set of interests for the group.

For instance, profile intersection determiner 604 may analyze retrieved profile information 612 to identify interest keywords (e.g., keywords associated with interest information, preference information, demographic information, etc.) that occur more often than others in the profile information of the different persons. These identified interest keywords may be used to define the set of interests for the group. Interest keywords that occur more often may be provided with higher weight or higher likelihood of inclusion in the set of interests, while interest keywords that occur less often may be provided with lower weight or less likelihood of inclusion in the set of interests. Some interest keywords that relate to requirements, such as food allergies, the presence of children, and/or physical handicaps, may be provided with higher weight or more likelihood of inclusion in the set of interests, even if their relative occurrence rate of occurrence in retrieved profile information 612 is low.

As such, profile intersection determiner 604 may generate conjoined interest set 316 to include a comprehensive list of weighted interest keywords or other search parameters for the group, to only include interest keywords or search parameters for the group that had the greatest weights (e.g., greater than a predetermined threshold weight value), and/or to include conjoined interest information for the group in another manner.

Furthermore, in an embodiment, profile intersection determiner 604 may enable the contents of conjoined interest set 316 to be manually tuned. For example, FIG. 8 shows a block diagram of a portion of communication system 100 of FIG. 1, in which profile intersection determiner 604 (in first server 104) enables tuning of group meeting preferences, according to an example embodiment. As shown in FIG. 4, profile intersection determiner 604 includes a preference tuner 802. Preference tuner 802 is configured to generate a user interface 806 to enable a person (e.g., coordinator for the group) to manually tune at least one preference for the group of persons.

As shown in FIG. 8, preference tuner 802 may generate a user interface definition 804, which is transmitted from first server 104 through network 110 to computing device 102a in a communication signal. User interface definition 804 may have any suitable form described elsewhere herein or otherwise known. User interface definition 804 defines a user interface that enables a user to manually tune preferences for the group.

For instance, as shown in FIG. 8, application 112 at computing device 102a may generate a user interface 806 based on user interface definition 804. For instance, application 112 may include a web browser that renders user interface 806 based on a web document version of user interface definition 804. Alternatively, user interface 806 may be generated in other ways based on user interface definition 804. User interface 806 may include any number and combination of user interface elements to enable preferences to be tuned, such as by adding new preferences, deleting preferences, and modifying existing preferences. A user at computing device 102a (e.g., a group coordinator) may be enabled to tune preferences in various ways by interacting with user interface 806, such as by entering preference values in a text box, selecting preference values from a contacts list, clicking on check buttons to select or deselect preferences, and/or in other ways.

In this manner, preference information in conjoined interest set 316 may be modified (e.g., modifying preferred restaurants, foods, drink types, stores, business locations, tourist destinations, etc.). As shown in FIG. 8, application 112 may generate a modified preference list 808 that indicates the modified preferences configured using user interface 806. Modified preference list 808 is transmitted from computing device 102a through network 110 to preference tuner 802 in first server 104. Preference tuner 802 may modify preferences included in conjoined interest set 316 based on modified preference list 808.

Referring back to FIG. 2, in step 206, locations of one or more persons in the group is/are determined. As shown in FIG. 3, location determiner 304 may receive determined group indication 312. Location determiner 304 may be configured to determine a location for one or more persons in the group defined by determined group indication 312. Furthermore, location determiner 304 may be configured to analyze the determined locations to generate an approximate geographical center location for the group. As shown in FIG. 3, location determiner 304 outputs the determined geographical center location as geographical center location 318.

In some cases, location determiner 304 may determine a location for each person, and in other cases, location determiner 304 may determine locations for fewer than all of the persons in the group (e.g., due to an inability to determine or access such location information, due to privacy settings of a user enabling them to opt-out of providing their location, etc.). In any event, location determiner 304 may be configured to determine locations for one or more persons in the group in various ways. For example, in an embodiment, location determiner 304 may receive an identifier signal 324, that includes an identifier such as an IP (Internet protocol) address or other identifier of a computing device of a user (e.g., for stationary devices). The identifier of identifier signal 324 may correspond to a geographic location for that computing device, and thereby to a geographic location of that user. In another embodiment, location determiner 304 may receive a location indication signal 326 from a computing device of a user that indicates the location of the computing device, and thereby indicates the geographic location of that user. The computing device may determine its location indicated in location indication signal 326 in any manner, including by a location determining technique such as GPS, cell tower triangulation, WLAN (wireless local area network) location determining techniques, by a user manually entering their position information into the computing device, and/or by other techniques. The location may be formatted in any manner, including in the form of an address (e.g., a street address, a city name, a postal code, etc.), in the form of geographic coordinates (e.g., latitude and longitude), etc.

Location determiner 304 may be configured to generate an approximate geographical center location for the group based on the plurality of determined locations of persons in the group in any manner. For instance, location determiner 304 may implement a geographic midpoint calculator that calculates a geographic midpoint as a “geographic center” or “center of gravity” (using Cartesian (x,y,z) coordinates; assumes Earth is a perfect sphere), may calculate the geographic center location by calculating a center of minimum distance (e.g., using the spherical law of cosines; assumes Earth is a perfect sphere), may calculate the geographic center location by calculating an average latitude/longitude (assumes Earth is flat; makes a close approximation for shorter distances between locations (e.g., less than 250 miles)), or may calculate the geographic center location in another manner, as would be known to persons skilled in the relevant art(s). In each case, each determined location for a person may be weighted according to the types and numbers of roads and intersections, traffic conditions, speed limits, etc., to take into account differences in travel time based on these conditions.

Referring back to FIG. 2, in step 208, local search results are received for the group of persons that are generated based on the conjoined interest set and the determined plurality of locations. As shown in FIG. 3, local search service interface 308 may receive conjoined interest set 316 and geographical center location 318. As described above, conjoined interest set 316 indicates a combined set of interests for the group of persons, and geographical center location 318 is an approximate geographical center location for the group. Local search service interface 308 is configured to communicate with a local search service, such as local search service 120 at second server 108 in FIG. 1, to obtain local search results for the group based on conjoined interest set 316 and geographical center location 318.

For example, as shown in FIG. 3, local search service interface 308 may transmit local search request 126 to the local search service. Local search request 126 may include information of conjoined interest set 316 (“what” is being searched for) and the determined central location for the group indicated by geographical center location 318 the (“where” information). The local search service may process the information of local search request 126 to select one or more possible meeting locations for the group, in a manner as would be known to persons skilled in the relevant art(s) (e.g., by querying an inverted index, etc.). For example, the local search service may determine a list of potential meeting places (e.g., restaurants, taverns, pubs, office buildings, etc.) that have characteristics with high relevance with regard to the information included in conjoined interest set 316. The determined potential meeting places may be weighted by the local search service based on how closely they match the information included in conjoined interest set 316 (closer matches are weighted higher), and based on how closely they are located to the central location for the group indicated by geographical center location 318 (shorter distances are weighted higher).

Note that the local search service (e.g., local search service 120 of FIG. 1) may be a proprietary or commercially available local search service. Examples of network accessible local search services include Bing™ Maps provided by Microsoft Corporation, Google Maps™ provided by Google Inc., and Yahoo!® Local provided by Yahoo! Inc.

The local search service may provide the one or more possible meeting locations in local search response 128, which is received by local search service interface 308. As shown in FIG. 3, local search service interface 308 may output local search results 322, which includes the possible meeting location(s) indicated in local search response 128.

Referring back to FIG. 2, in step 210, the local search results are enabled to be presented to at least one person of the group of persons. As shown in FIG. 3, output interface 310 may receive local search results 322. Output interface 310 is configured to transmit local search results 322 to one or more of computing devices 102a-102n (FIG. 1) as local search results 130. Local search results 130 may be received by the computing devices, and displayed or otherwise presented to the associated user(s).

For instance, FIG. 9 shows a block diagram of a portion of communication system 100 of FIG. 1, in which output interface 308 enables local search results and related statistics to be presented, according to an example embodiment. As shown in the example of FIG. 9, output interface 308 is configured to generate a user interface 806 to enable a person (e.g., coordinator for the group or other person) to review the possible meeting locations of local search results 130.

As shown in FIG. 9, output interface 308 may generate a user interface definition 904 based on local search results 322, which is transmitted from first server 104 through network 110 to computing device 102a in a communication signal. User interface definition 904 may have any suitable form described elsewhere herein or otherwise known. User interface definition 904 defines a user interface that enables a user to review (e.g., view and/or hear) the one or more possible meeting locations of local search results 130.

For instance, as shown in FIG. 9, application 112 at computing device 102a may generate a user interface 906 based on user interface definition 904. Application 112 may include a web browser that renders user interface 906 based on a web document version of user interface definition 904. Alternatively, user interface 906 may be generated in other ways based on user interface definition 904. User interface 906 may include any number and combination of user interface elements to enable meeting locations of local search results 130 to be presented. For instance, user interface 906 may display one or more meeting locations, may play voice that recites the one or more meeting locations, or may otherwise present the one or more meeting locations. A user at computing device 102a (e.g., a group coordinator) may be enabled to interact with user interface 906 to select one of the meeting locations to be used by the group. Alternatively, all of the users of the group may be presented with user interface 906 at their computing devices, so that the users can interact with user interface 906 to vote on and thereby select one of the meeting locations to be used by the group (e.g., by a displayed vote tally, etc.).

Furthermore, in an embodiment, a statistics generator 902 may be present in first server 104 as shown in FIG. 9. Statistics generator 902 may be present in a meeting system to generate and/or enable display of statistics related to conjoined interest set 316. For instance, in an embodiment, statistics generator 902 may calculate a frequency (e.g., a number of appearances) of each unique keyword in conjoined interest set 316, may calculate a percentage of the persons of the group with which each keyword is associated, and/or may calculate other statistics regarding conjoined interest set 316.

As shown in FIG. 9, statistics generator 902 may output statistics 908, which includes the statistics calculated based on conjoined interest set 316. Statistics 908 may be transmitted by output interface 308 through network 110 to computing device 102a to be displayed in user interface 906.

In an embodiment, when present, statistics generator 902 may be a separate element of a meeting system. In another embodiment, statistics generator 902 may be included in another element of the meeting system, such as being included in interest set generator 306 (of FIG. 3).

B. Illustrative Examples of Meeting Place Determination

A meeting place for a group may be determined in various ways according to embodiments described herein. Some example embodiments are described as follows with respect to FIGS. 10-15, 16A, and 16B to illustrate operation of flowchart 200 (FIG. 2) and meeting systems 118 and 300 (FIGS. 1 and 3). These embodiments are provided for purposes of illustration, and are not intended to be limiting. Persons skilled in the relevant art(s) will recognize numerous variations to the example embodiments of FIGS. 10-15, 16A, and 16B based on the teachings herein, and such variations are also within the scope of the present patent application.

In particular, FIGS. 10-15, 16A, and 16B show block diagrams of user interfaces that enable a meeting location to be determined for a group, according to example embodiments. The user interfaces of FIGS. 10-15, 16A, and 16B are shown as having dimensions suitable for a smart phone display screen, but in other embodiments, may have other formats and/or dimensions suitable for display screens of other types of devices described elsewhere herein or otherwise known (e.g., a desktop computer, a laptop, a tablet, glasses having lenses that function as display screens, a wristwatch having a display screen, etc.). Furthermore, alternative types, combinations, and sequences of user interfaces may be presented than shown in FIGS. 10-15, 16A, and 16B that may be used to enable a meeting location to be determined for the group, as would be apparent to persons skilled in the relevant art(s) from the teachings herein.

In the examples of FIGS. 10-15, 16A, and 16B, a first person (“Anna Jones”) interacts with a computing device having a display screen that displays the user interfaces of FIGS. 10-15, 16A, and 16B. This first person may be considered a group coordinator for the group. In FIG. 10, the first person is communicating with a second person (“Emily Smith”) in a message thread 1004 (e.g., by text messaging) displayed in a user interface 1002. In message thread 1004, the location of the second user (“The Drake Hotel”) is indicated. A user interface element 1006 is displayed in user interface 1002 (e.g., a virtual button) displaying the text “Meet Up” that may be interacted with to initiate determining a meeting location for a group.

In this example, the first user decides to interact with user interface element 1006 (e.g., by touch) to initiate functionality for determining a meeting location for a group. In an embodiment, in response to interaction with user interface element 1006, a user interface 1102 shown in FIG. 11 is displayed in the display screen. For instance, user interface 1102 may be generated by group determiner 302 (e.g., as shown in FIG. 4). User interface 1102 displays a “Meet Up” home screen, which includes a listing 1106 of group members (e.g., determined according to step 202 of FIG. 2), a first user interface element 1108 (e.g., a virtual button) displaying the text “Set Filters,” and a second user interface element 1110 (e.g., a virtual button) displaying the text “Launch.” In this example, listing 1106 includes “Anna” and “Emily”, which may have been automatically determined by automatic group generator 404 of FIG. 4 based on a parsing of message thread 1004. At this point, the first user may interact with first user interface element 1108 to set filters with regard to the determination of the meeting location, or the first user may interact with second user interface element 1110 to have possible meeting locations generated.

For instance, user interface 1202 shown in FIG. 12 may be displayed if the user opts to launch the meeting place determination by interacting with second user interface element 1110 in FIG. 11. User interface 1202 displays a ranked list 1204 of potential meeting locations. Ranked list 1204 may have been determined as described above (e.g., with respect to steps 204, 206, and 208 shown in FIG. 2), and displayed in user interface 1202 by output interface 308 (e.g., as shown in FIG. 9) as described above (e.g., with respect to step 210 of FIG. 2). In the example of FIG. 12, three potential meeting locations are displayed for ranked list 1204 (shown ranked 1-3), although other numbers of locations may be displayed alternatively. Any information may be displayed that is descriptive of each of the potential meeting locations, including location name, distance from the group central location, rating, address, and/or any other suitable descriptive information.

Note that in another embodiment, when user interface element 1006 is interacted with in FIG. 10, user interface 1202 may be directly generated and displayed to the user (without first displaying user interface 1102 of FIG. 11). In this manner, each of steps 202, 204, 206, 208, and 210 of flowchart 210 may be performed in response to a single user interface interaction (e.g., a “one click” meeting location selection).

User interface 1302 shown in FIG. 13 may be displayed if the user opts to set filters with regard to the determination of the meeting location by interacting with second user interface element 1110 in FIG. 11. User interface 1302 displays a filter set 1304 that may be used to tune preferences, modify the group members, and/or tune other parameters. Filter set 1304 may be generated by preference tuner 802 shown in FIG. 8. In the example of FIG. 13, filter set 1304 includes first-third user interface elements 1306, 1308, and 1310, a first user interface element set 1312, and a second user interface element set 1314. First user interface element 1306 is a text entry box that lists the current persons in the group. Second user interface element 1308 is a virtual button that can be interacted with to be enabled to modify the group members. Third user interface element 1310 is a pull down menu that enables various selections to be made for sorting search results (e.g., sorting the potential meeting locations by distance, price, etc.). First user interface element set 1312 is a set of check boxes that enable various categories of potential meeting locations to be displayed or not displayed (e.g., places that are open, places that are offering a deal, etc.). Second user interface element set 1314 is a set of check boxes that enable various cuisines to be displayed or not displayed (filtered out) (e.g., African cuisine, American cuisine, etc.). Each of sets 1312 and 1314 may include any number of selections having corresponding check boxes.

User interface 1402 shown in FIG. 14 may be displayed if the user opts to modify the members of the group by interacting with second user interface element 1308 in FIG. 13. For instance, user interface 1402 may display a contact list maintained by the first user's computing device. User interface 1402 may be interacted with to navigate through the contact list to find one or more additional persons to add to the group. User interface 1402 displays a user interface element 1406 (e.g., a virtual button) that may be interacted with when finished adding persons to the group.

User interface 1502 shown in FIG. 15 may be displayed after the first user interacted with user interface 1402 of FIG. 14 to add a new group member (“Miles White”). User interface 1502 is the same as user interface 1102 of FIG. 11, except that listing 1106 of group members on FIG. 15 includes three persons (“Anna”, “Emily”, and “Miles”) rather than two persons. Note that a user interface element next to each displayed person in listing 1106 may be interacted with to delete the corresponding person from the group.

User interface 1602 shown in FIG. 16A may be displayed if the user opts to launch the meeting place determination by interacting with second user interface element 1110 in FIG. 15. User interface 1602 is generally similar to user interface 1202 shown in FIG. 12, displaying a ranked list 1604 of potential meeting locations. Ranked list 1604 may have been determined as described above (e.g., with respect to steps 204, 206, and 208 shown in FIG. 2), and displayed in user interface 1602 by output interface 308 (e.g., as shown in FIG. 9) as described above (e.g., with respect to step 210 of FIG. 2). In the example of FIG. 16A, three potential meeting locations are displayed for ranked list 1604 (shown ranked 1-3), although other numbers of locations may be displayed alternatively. The set of potential meeting locations displayed for ranked list 1604 is different than the set of potential meeting location displayed for ranked list 1204 in FIG. 12 due to the addition of the third person to the group (“Miles”). This may be because the third person's profile information was included in the analysis performed by interest set generator 306 of FIG. 3 (in addition to the profile information of the first two users), leading to a different conjoined interest set 316 being generated. For instance, the third person may be intolerant to gluten, which may be indicated in the third person's profile information, and which may have led to a gluten free restaurant being ranked highly in ranked list 1204.

FIG. 16B shows an alternative version of user interface 1602. In FIG. 16B, user interface 1602 displays ranked list 1604 of potential meeting locations, and further displays statistics 1606. Statistics 1606 may be generated by statistics generator 902 of FIG. 9, and may indicate various statistics related to the group. For instance, in FIG. 16B, statistics 1606 indicate a percentage of the group members that had preferences for vegetables (66%), for wine (33%), and for a highly rated restaurant (100%) in a desired meeting location.

C. Example Application Embodiments

Application 112, mobile app 124, and web application 116, which execute at computing devices 102a, 102b, and 102n of FIG. 1, respectively, encompass many types of applications. For instance, application 112 may be an office suite application, a desktop application, a mobile application, a web application, or any other type of application capable of being run on computing device 102a. Office suite applications include various types of productivity enhancing applications, such as messaging applications, word processing applications, spreadsheet applications, presentation applications, etc. Desktop applications include various types of applications that configured to operate in computer desktops (e.g., of desktop computers), including some office suite applications, desktop widgets or gadgets (interactive tools that typically provide single purpose services, such as news streaming, providing the current weather, showing current stock quotes, etc.), etc.

Mobile app 124 is an application configured to run on a mobile device, which may be downloaded to computing device 102b through an application distribution platform or otherwise obtained. Examples of application distribution platforms for mobile apps include the Apple® App Store provided by Apple Inc. of Cupertino, Calif., Google® Play™ provided by Google Inc., the Microsoft® Windows® Phone Store provided by Microsoft Corp., the Microsoft® Store Online, and BlackBerry® App World™ provided by Research in Motion Limited of Waterloo, Ontario, Canada.

Web application 116 may be an application that may be accessed by over a network (e.g., network 110), and/or may be an application that is coded in a browser-supported programming language (e.g., JavaScript, combined with a browser-rendered markup language such as HTML (hypertext markup language)) and executes in a web browser to render the application executable. Examples of suitable web browsers include Internet Explorer®, developed by Microsoft Corp., Mozilla Firefox®, developed by Mozilla Corp. of Mountain View, Calif., Safari®, developed by Apple Inc., and Google® Chrome. Examples of applications that may be run in a browser and/or a mobile app interface include social networking applications, search engines, navigational assistance applications (e.g., mapping applications, restaurant locating applications, traffic applications, etc.), gaming applications, financial planning applications, etc.

D. Example Computing Device and Server Embodiments

Application 112, mobile app 124, web application 116, meeting system 118, local search service 120, meeting system 300, group determiner 302, location determiner 304, interest set generator 306, local search service interface 308, output interface 310, manual input enabler 402, automatic group generator 404, profile information retriever 602, profile intersection determiner 604, social network 606, search engine 608, messaging server 610, message thread analyzer 702, preference tuner 802, statistics generator 902, flowchart 200, and flowchart 500 may be implemented in hardware, or hardware combined with software and/or firmware. For example, application 112, mobile app 124, web application 116, meeting system 118, local search service 120, meeting system 300, group determiner 302, location determiner 304, interest set generator 306, local search service interface 308, output interface 310, manual input enabler 402, automatic group generator 404, profile information retriever 602, profile intersection determiner 604, social network 606, search engine 608, messaging server 610, message thread analyzer 702, preference tuner 802, statistics generator 902, flowchart 200, and/or flowchart 500 may be implemented as computer program code/instructions configured to be executed in one or more processors and stored in a computer readable storage medium. Alternatively, application 112, mobile app 124, web application 116, meeting system 118, local search service 120, meeting system 300, group determiner 302, location determiner 304, interest set generator 306, local search service interface 308, output interface 310, manual input enabler 402, automatic group generator 404, profile information retriever 602, profile intersection determiner 604, social network 606, search engine 608, messaging server 610, message thread analyzer 702, preference tuner 802, statistics generator 902, flowchart 200, and/or flowchart 500 may be implemented as hardware logic/electrical circuitry.

For instance, in an embodiment, one or more of meeting system 118, local search service 120, meeting system 300, group determiner 302, location determiner 304, interest set generator 306, local search service interface 308, output interface 310, manual input enabler 402, automatic group generator 404, profile information retriever 602, profile intersection determiner 604, message thread analyzer 702, preference tuner 802, statistics generator 902, flowchart 200, and/or flowchart 500 may be implemented together in a system-on-chip (SoC). The SoC may include an integrated circuit chip that includes one or more of a processor (e.g., a microcontroller, microprocessor, digital signal processor (DSP), etc.), memory, one or more communication interfaces, and/or further circuits and/or embedded firmware to perform its functions.

FIG. 17 depicts an exemplary implementation of a computing device 1700 in which embodiments of the present invention may be implemented. For example, computing devices 102a-102n, first server 104, and/or server 108 may be implemented in one or more computing devices similar to computing device 1700, including one or more features of computing device 1700 and/or alternative features. The description of computing device 1700 provided herein is provided for purposes of illustration, and is not intended to be limiting. Embodiments of the present invention may be implemented in further types of computer systems, as would be known to persons skilled in the relevant art(s).

As shown in FIG. 17, computing device 1700 includes one or more processors 1702, a system memory 1704, and a bus 1706 that couples various system components including system memory 1704 to processor 1702. Bus 1706 represents one or more of any of several types of bus structures, including a memory bus or memory controller, a peripheral bus, an accelerated graphics port, and a processor or local bus using any of a variety of bus architectures. System memory 1704 includes read only memory (ROM) 1708 and random access memory (RAM) 1710. A basic input/output system 1712 (BIOS) is stored in ROM 1708.

Computing device 1700 also has one or more of the following drives: a hard disk drive 1714 for reading from and writing to a hard disk, a magnetic disk drive 1716 for reading from or writing to a removable magnetic disk 1718, and an optical disk drive 1720 for reading from or writing to a removable optical disk 1722 such as a CD ROM, DVD ROM, or other optical media. Hard disk drive 1714, magnetic disk drive 1716, and optical disk drive 1720 are connected to bus 1706 by a hard disk drive interface 1724, a magnetic disk drive interface 1726, and an optical drive interface 1728, respectively. The drives and their associated computer-readable media provide nonvolatile storage of computer-readable instructions, data structures, program modules and other data for the computer. Although a hard disk, a removable magnetic disk and a removable optical disk are described, other types of computer-readable storage media can be used to store data, such as flash memory cards, digital video disks, random access memories (RAMs), read only memories (ROM), and the like.

A number of program modules may be stored on the hard disk, magnetic disk, optical disk, ROM, or RAM. These programs include an operating system 1730, one or more application programs 1732, other program modules 1734, and program data 1736. Application programs 1732 or program modules 1734 may include, for example, computer program logic (e.g., computer program code or instructions) for implementing application 112, mobile app 124, web application 116, meeting system 118, local search service 120, meeting system 300, group determiner 302, location determiner 304, interest set generator 306, local search service interface 308, output interface 310, manual input enabler 402, automatic group generator 404, profile information retriever 602, profile intersection determiner 604, message thread analyzer 702, preference tuner 802, statistics generator 902, flowchart 200, and/or flowchart 500 (including any step of flowcharts 200 and 500), and/or further embodiments described herein.

A user may enter commands and information into the computing device 1700 through input devices such as keyboard 1738 and pointing device 1740. Other input devices (not shown) may include a microphone, joystick, game pad, satellite dish, scanner, a touch screen and/or touch pad, a voice recognition system to receive voice input, a gesture recognition system to receive gesture input, or the like. These and other input devices are often connected to processor 1702 through a serial port interface 1742 that is coupled to bus 1706, but may be connected by other interfaces, such as a parallel port, game port, or a universal serial bus (USB).

A display screen 1744 is also connected to bus 1706 via an interface, such as a video adapter 1746. Display screen 1744 may be external to, or incorporated in computing device 1700. In addition to display screen 1744, computing device 1700 may include other peripheral output devices (not shown) such as speakers and printers.

Computing device 1700 is connected to a network 1748 (e.g., the Internet) through an adaptor or network interface 1750, a modem 1752, or other means for establishing communications over the network. Modem 1752, which may be internal or external, may be connected to bus 1706 via serial port interface 1742, as shown in FIG. 17, or may be connected to bus 1706 using another interface type, including a parallel interface.

As used herein, the terms “computer program medium,” “computer-readable medium,” and “computer-readable storage medium” are used to generally refer to media such as the hard disk associated with hard disk drive 1714, removable magnetic disk 1718, removable optical disk 1722, as well as other media such as flash memory cards, digital video disks, random access memories (RAMs), read only memories (ROM), and the like. Such computer-readable storage media are distinguished from and non-overlapping with communication media (do not include communication media). Communication media typically embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media. Embodiments are also directed to such communication media.

As noted above, computer programs and modules (including application programs 1732 and other program modules 1734) may be stored on the hard disk, magnetic disk, optical disk, ROM, or RAM. Such computer programs may also be received via network interface 1750, serial port interface 1742, or any other interface type. Such computer programs, when executed or loaded by an application, enable computing device 1700 to implement features of embodiments of the present invention discussed herein. Accordingly, such computer programs represent controllers of the computing device 1700.

The invention is also directed to computer program products comprising software stored on any computer useable medium. Such software, when executed in one or more data processing devices, causes a data processing device(s) to operate as described herein. Embodiments of the present invention employ any computer-useable or computer-readable medium, known now or in the future. Examples of computer-readable mediums include, but are not limited to storage devices such as RAM, hard drives, floppy disks, CD ROMs, DVD ROMs, zip disks, tapes, magnetic storage devices, optical storage devices, MEMs, nanotechnology-based storage devices, and the like.

### VI. Conclusion

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A method for determining a meeting location, comprising:
determining a group of persons to meet;
generating a conjoined interest set that is representative of the group of persons;
determining locations for persons in the group to determine a plurality of locations;
receiving local search results for the group of persons generated based on the conjoined interest set and the determined plurality of locations, the local search results including at least one potential meeting location; and
enabling the local search results to be presented to at least one person of the group of persons.

2. The method of claim 1, wherein said determining a group of persons comprises:
enabling the group of persons to be manually defined.

3. The method of claim 1, wherein said determining a group of persons comprises:
automatically generating the group of persons.

4. The method of claim 3, wherein said automatically generating the group of persons comprises:
generating the group of persons by performing at least one of
generating the group to include persons from an eligible persons pool that are determined to be located in a particular geographical area,
generating the group to include persons from an eligible persons pool that are determined to be located within a particular radial distance from a location designated by a coordinator for the group,
generating the group to include persons from an eligible persons pool that are determined to be located within a particular travel time from a location designated by a coordinator for the group; or
generating the group based on a grouping of persons formed online.

5. The method of claim 3, wherein said automatically generating the group of persons comprises:
analyzing a message thread to determine persons that were participating together in the messaging thread to include in the group.

6. The method of claim 1, wherein said generating a conjoined interest set that is representative of the group of persons comprises:
retrieving profile information for persons of the group; and
determining an intersection of the retrieved profile information to generate the conjoined interest set.

7. A system for determining a meeting location, comprising:
a group determiner configured to determine a group of persons to meet;
an interest set generator configured to generate a conjoined interest set that is representative of the group of persons;
a location determiner configured to determine locations of persons in the group to determine a plurality of locations;
a local search service interface configured to receive local search results for the group of persons generated based on the conjoined interest set and the determined plurality of locations, the local search results including at least one potential meeting location; and
an output interface configured to enable the local search results to be presented to at least one person of the group of persons.

8. The system of claim 7, wherein the group determiner is configured to generate a user interface to enable the group of persons to be manually defined.

9. The system of claim 7, wherein the group determiner is configured to automatically generate the group of persons.

10. The system of claim 9, wherein the group determiner is configured to generate the group to include persons from an eligible persons pool that are determined to be located in a particular geographical area, generate the group to include persons from an eligible persons pool that are determined to be located within a particular radial distance from a location designated by a coordinator for the group, generate the group to include persons from an eligible persons pool that are determined to be located within a particular travel time from a location designated by a coordinator for the group, or generate the group based on a grouping of persons formed online.

11. The system of claim 9, wherein the group determiner is configured to generate a user interface to enable a coordinator for the group to manually modify the automatically generated group of persons.

12. The system of claim 7, wherein the interest set generator comprises:
a profile information retriever that is configured to retrieve profile information for persons of the group; and
a profile intersection determiner configured to determine an intersection of the retrieved profile information to generate the conjoined interest set.

13. The system of claim 12, wherein the profile information retriever is configured to receive profile information for at least one person of the group from at least one of a social network, a search engine, or contact information associated with the person.

14. The system of claim 12, wherein the profile information retriever comprises:
a message thread analyzer configured to analyze a message thread of at least one person of the group for at least one of interest information, time information, or meeting place suggestions.

15. The system of claim 12, wherein the retrieved profile information indicates a location of residence for at least one person of the group, whether the at least one person has children, an age of the at least one person, a sex of the at least one person, and at least one specific interest of the at least one person.

16. The system of claim 7, wherein the interest set generator comprises:
a preference tuner configured to generate a user interface to enable a coordinator for the group to manually tune at least one preference for the group of persons.

17. The system of claim 7, further comprising:
a statistics generator configured to generate statistics associated with the conjoined interest set to be presented by the output interface to at least one person of the group of persons.

18. A computer readable storage medium having computer program instructions stored in the computer readable storage medium that enable a processor to determine a meeting location, the computer program instructions comprising:
first computer program instructions that enable the processor to determine a group of persons, and to enable a coordinator of the determined group of persons to modify the determined group of persons;
second computer program instructions that enable the processor to generate a conjoined interest set that is representative of the group of persons;
third computer program instructions that enable the processor to determine locations of persons in the group to determine a plurality of locations;
fourth computer program instructions that enable the processor to retrieve local search results for the group of persons generated based on the conjoined interest set and the determined plurality of locations, the local search results including at least one potential meeting location for the group of persons; and
fifth computer program instructions that enable the processor to enable the local search results to be presented at least to the coordinator for the group to select a meeting location for the group from the local search results.

19. The computer readable storage medium of claim 18, wherein said second computer program instructions comprises:
computer program instructions that enable the processor to retrieve profile information for persons of the group; and
computer program instructions that enable the processor to determine an intersection of the retrieved profile information to generate the conjoined interest set.

20. The computer readable storage medium of claim 18, wherein said second computer program instructions comprises:
computer program instructions that enable the processor to enable the coordinator for the group to manually tune at least one preference for the group of persons.
